(19) United States
(12) Patent Application Publication
(10) Pub. No.: US 2008/0250895 A1
(43) Pub. Date: Oct. 16, 2008

(54) Rotating Assembly and Its Manufacturing Method

(76) Inventors: Tamotsu Yamamoto, Aichi (JP); Eiji Isogai, Aichi-ken (JP); Kazumasa Kinoshita, Aichi-ken (JP); Kunihiro Nishimura, Aichi-ken (JP); Hidekazu Sato, Aichi-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/594,572

(22) PCT Filed: Jan. 19, 2006
(86) PCT No.: PCT/JP2006/000711

§ 371 Date: Sep. 27, 2006

(30) Foreign Application Priority Data
Jan. 20, 2005 (JP) 2005012597

(51) Int. Cl. F16H 53/02; B23P 11/00

(52) U.S. Cl. 74/567; 29/447

(57) ABSTRACT

An inner hole 31 to which a driving shaft 2 is inserted is formed in a campiece 3 of a camshaft 1, and a plurality of grooves 34 extending in the insertion direction of the driving shaft 2 are formed in the inner hole 31. The driving shaft 2 is inserted into the inner hole 31 with the cam piece 3 heated to expand the diameter of the inner hole 31. By reducing again the diameter of the inner hole 31 by cooling it in this state, an outer circumferential surface of the driving shaft 2 is pressed and raised by the inner hole 31 and enters the groove 34, by which the cam piece 3 is firmly fixed onto the driving shaft 2.

### TECHNICAL FIELD

The present invention relates to a rotating assembly in which a rotating member is fastened onto a shaft and its manufacturing method.

### BACKGROUND ART

There is a conventional art in which an inner hole having a stepped portion is formed on a cam piece, a pipe-shaped shaft is inserted into this inner hole and then, a high-pressure fluid is injected into the shaft to expand it outward so that the shaft is accommodated in the stepped portion of the inner hole so as to fix the cam piece onto the shaft (See Patent Document 1, for example). According to this technique, a fastening strength between the cam piece and the shaft can be improved by a portion accommodated in the stepped portion of the shaft as a hook.
Patent Document 1: Japanese Patent Laid-Open No. 2003-314576

However, it is necessary to inject a high-pressure fluid into a shaft in order to form a camshaft by the above-mentioned conventional art, which requires a large amount of labor and many processes as well as equipment such as a high-pressure fluid source, a shaft sealing apparatus or the like for the manufacture. There is a method in which, after expanding a diameter of an inner hole by heating the camshaft without injecting high pressure, the shaft is inserted into the inner hole and cooled for fixation. But the inner hole is pressed by the shaft and the surface shape of the cam piece is affected by that and changed, and it is necessary to polish the surface of the cam piece in order to correct the problem.

The present invention was made based on the above circumstances and has an object to provide a rotating assembly which can fix a rotating member easily onto a shaft and its manufacturing method.

### BRIEF SUMMARY OF THE INVENTION

As means to achieve the above object, a rotating assembly according to the present invention in which a rotating member is fixed onto a shaft by inserting the shaft into an inner hole of the rotating member is characterized in that a diameter of the inner hole is formed smaller than an outer diameter of an insertion portion of the shaft, and a plurality of grooves extending in the insertion direction are formed on one of the inner hole and an outer circumferential surface of the shaft, after the diameter of the inner hole is expanded by heating the rotating member, the shaft is inserted into the inner hole and cooled to reduce the diameter of the inner hole again, the other of the inner hole and the outer circumferential surface of the shaft is pressed and raised by the other part and enters the grooves so that both of them are fixed and formed.

In this way, one of the inner hole and the outer circumferential surface of the shaft is pressed and raised by the other and enters the grooves so that both of them are fixed. Thus, the portions having entered into the grooves serve as a hook, and the rotating member can be firmly fixed on to the shaft easily. Moreover, before attaching the rotating member onto the shaft, an area of the inner hole brought into contact with a gauge or the like is reduced by the presence of the grooves when inserting a gauge for inspection or the like into the inner hole. Therefore, a resistance at insertion can be reduced, and inspection workability can be improved.

As embodiments of the present invention, the following constructions are preferable:
(1) The rotating member is a cam piece having a circumferential-shaped outer circumferential surface surrounding the inner hole and a cam profile continuing to this outer circumferential surface and projecting outward, the plurality of grooves are formed in the inner hole, and by inserting the driving shaft into the inner hole, the cam piece is fastened onto the inner hole so as to form a camshaft.

By this, when the cam piece is fixed to the driving shaft, the driving shaft enters the groove, which relaxes a pressing force of the driving shaft applied to the cam piece and prevents shape change of the cam profile.

(2) In the above description in (1), at a portion in the inner hole positioned inward of the location where the circumferential-shaped outer circumferential surface continues to the cam profile, a large-diameter escape portion is formed to prevent contact with the outer circumferential surface of the driving shaft when the cam piece is fastened to the driving shaft.

By this, the shape of the location of an outline of the cam piece, which is close to the inner hole and continuing to the cam profile for controlling a work amount of a valve member of an engine, can be prevented from being changed by fastening of the cam piece to the driving shaft.

(3) In the above description in (1) or (2), a hardness of the inner hole of the cam piece is higher than the hardness of the outer circumferential surface of the driving shaft.

By this, when the cam piece is fixed to the driving shaft, the driving shaft is raised and easily enters the grooves, by which both are firmly fixed. And since deformation on the cam piece side is small, influence on the shape of the cam profile can be reduced.

(4) As a method for manufacturing a rotating assembly, in a manufacturing method of a rotating assembly in which a rotating member is fixed onto a shaft by inserting the shaft into an inner hole of the rotating member, a diameter of the inner hole is formed smaller than an outer diameter of an insertion portion of the shaft, a plurality of grooves extending in the insertion direction are formed on one of the inner hole and an outer circumferential surface of the shaft, after the diameter of the inner hole is expanded by heating the rotating member, the shaft is inserted into the inner hole and cooled to reduce the diameter of the inner hole again, the other of the inner hole and the outer circumferential surface of the shaft is pressed and raised by the other part and enters the grooves so that both are fixed.

By this, one of the inner hole and the outer circumferential surface of the shaft is pressed and raised by the other and enters the grooves so that both of them are fixed. Thus the portions having entered the grooves serve as a hook, by which the rotating member can be firmly fixed onto the shaft in a simple method. Moreover, when the rotating member is fixed to the shaft, one of the inner hole and the outer circumferential surface of the shaft enters the grooves, which relaxes a pressing force received by the rotating member from the shaft and can prevent deformation of the outer shape.

According to the rotating assembly and its manufacturing method of the present invention, the rotating member can be easily fixed onto the shaft.

### BRIEF DESCRIPTION OF THE DRAWINGS

FIG. 1 is a partial view of an appearance of a camshaft according to an embodiment 1 of the present invention;

FIG. 2 is a front view of the cam piece shown in FIG. 1;

FIG. 3 is an A-A sectional view of FIG. 1;

FIG. 4 is an enlarged view of an essential part of FIG. 3;

FIG. 5 is an enlarged view of an essential part showing a variation 1 of the embodiment 1 (A), an enlarged view of an essential part showing a variation 2 (B), and an enlarged view of an essential part showing a variation 3 (C); and

FIG. 6 is a sectional view of the camshaft according to an embodiment 2.

### DESCRIPTION OF SYMBOLS

1 . . . Camshaft
2 . . . Driving shaft
3 . . . Cam piece
31 . . . Inner hole
32 . . . Circumferential-shaped outer circumferential surface
33 . . . Cam profile
34 . . . Groove
36 . . . Raised portion
37 . . . Escape portion

### BEST MODE FOR CARRYING OUT THE INVENTION

### Embodiment 1

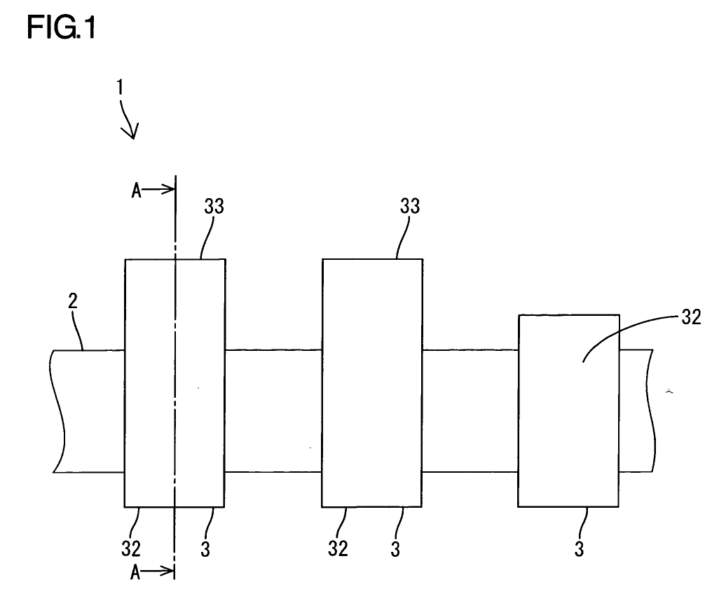

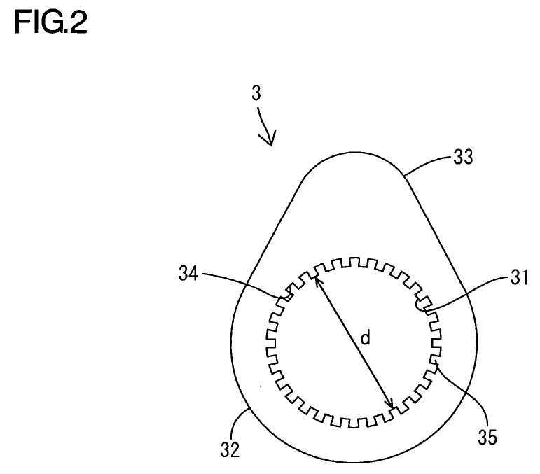

An embodiment 1 of the present invention will be described referring to FIGS. 1 to 5. As shown in FIG. 1, a camshaft 1, which is a rotating assembly according to this embodiment, has a plurality of cam pieces 3 fastened and formed on a driving shaft 2. The driving shaft 2 is formed by a pipe material made of a carbon steel or an alloy steel such as STKM material. The cam piece 3 is formed by a sintered material obtained by pressurizing and molding a metal powder of a carbon steel or an alloy steel containing Cr, V in a die and sintering it at a high temperature. As shown in FIG. 2, an inner hole 31 pierces the inside of the cam piece 3, and an inner diameter d of the inner hole 31 is formed smaller than an outer diameter of an insertion portion of the driving shaft 2. Moreover, in the cam piece 3, a circumferential-shaped outer circumferential surface 32 is formed surrounding a part of the inner hole 31, and furthermore, a camprofile 33 projecting outward is formed continuing to the outer circumferential surface 32.

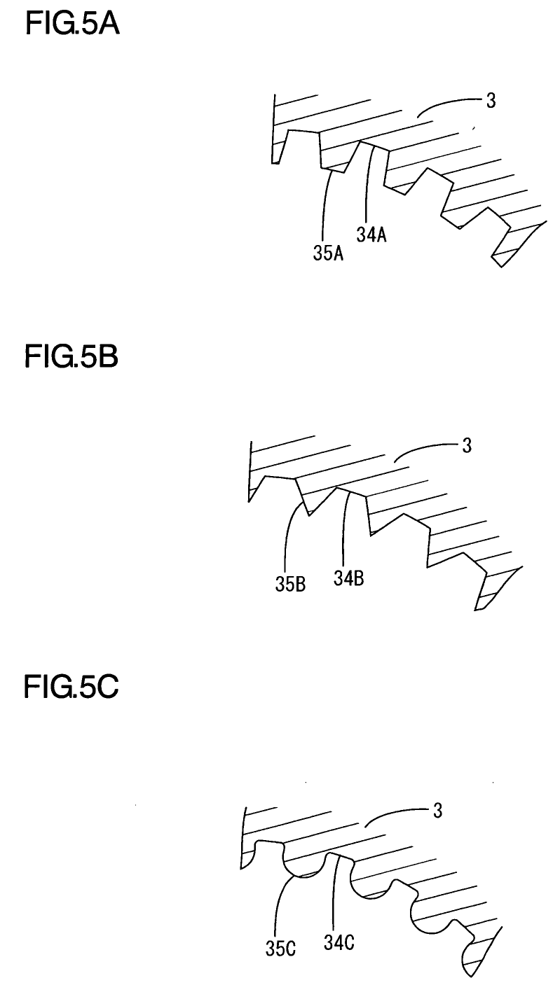

Plurality of grooves 34 extending in a direction (which will be described later) in which the driving shaft 2 is inserted into the cam piece 3 are formed on the inner hole 31. The grooves 34 are formed so that they are arranged evenly on the inner hole 31. In the cam piece 3 shown in FIG. 2, since a section of each of projection portions 35 arranged between the grooves 34 is formed in a rectangular shape in cross section, the section of the groove 34 is also formed in the rectangular shape in cross section. But by making it as a projection portion 35A with a trapezoidal section as shown in FIG. 5(A), a projection portion 35B with a triangular section as shown in FIG. 5(B) or a projection portion 35C with a circular section as shown in FIG. 5(C), a similar effect can be obtained even if the sectional shape of the grooves 34A, 34B, 34C arranged between each of them is changed as appropriate. A hardness of at least the inner hole 31 of the cam piece 3 is not less than Hv 350, though not limited to this, which is formed higher than the hardness of the outer circumferential surface of the driving shaft 2 (Hv 150 to 200). The groove 34 may be formed at the same time with the outer shape at molding of the cam piece 3, but the cam piece 3 may be sintered after forming by machining after molding of the outer shape of the cam piece 3.

Next, a method for fastening the cam piece 3 onto the driving shaft 2 will be described. First, the cam piece 3 with a plurality of grooves 34 formed in the inner hole 31 is heated at a high temperature of not less than 200° C. so as to expand the inner diameter d of the inner hole 31. In this state, the driving shaft 2 is inserted into the inner hole 31 of the cam piece 3 in the length direction (shrink fitting). Since the diameter of the inner hole 31 has been expanded by heating, insertion of the driving shaft 2 can be carried out smoothly.

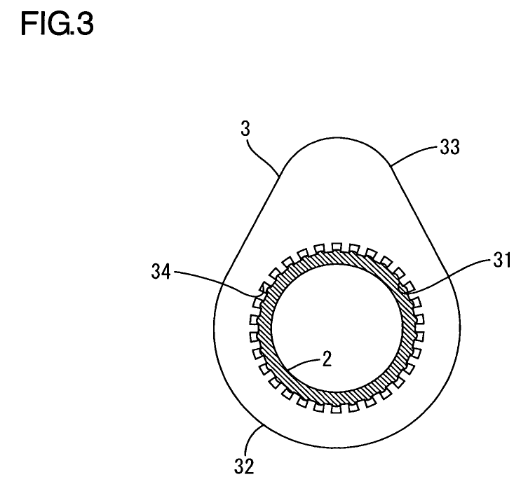

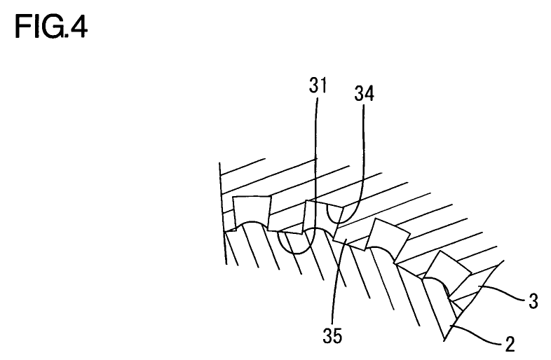

Next, when the driving shaft 2 is cooled while being inserted into the inner hole 31 of the plurality of cam pieces 3, the diameter of the inner hole 31 which has been expanded is reduced again, which begins to press the outer circumferential surface of the driving shaft 2 inward. Therefore, the outer circumferential surface of the driving shaft 2 with a hardness lower than that of the inner hole 31 is pressed by the inner hole 31, portions opposite to the grooves 34 not bound by the inner hole 31 are raised outward, and each of them enters the grooves 34 (See FIGS. 3 and 4). By this, the driving shaft 2 and the cam piece 3 are firmly fixed to each other, and the camshaft 1 is completed. The camshaft 1 is rotatably fixed in a cylinder head in an internal combustion engine, not shown, and is rotated to control operation of an intake/exhaust valve in contact with the cam profile 33.

According to this embodiment, the outer circumferential surface of the driving shaft 2 is pressed and raised by the inner hole 31 and enters the groove 34 and both of them are fixed to each other. Thus, the portions having entered the groove 34 serve as a hook and the cam piece 3 can be firmly fixed onto the driving shaft 2 with an easy method. Also, when a gauge for inspection or the like, not shown, is to be inserted into the inner hole 31 to inspect accuracy of the inner diameter d of the inner hole 31 before mounting the cam piece 3 to the driving shaft 2, an area of the inner hole 31 in contact with the gauge or the like is reduced by the presence of the groove 34, resistance at insertion can be reduced, and inspection workability is improved. Also, when the cam piece 3 is fixed to the driving shaft 2, the driving shaft 2 enters the groove 34, and a pressing force received by the cam piece 3 from the driving shaft 2 is relaxed and the shape of the cam profile 33 is not changed.

Moreover, since the hardness of the inner hole 31 of the cam piece 3 is higher than the hardness of the outer circumferential surface of the driving shaft 2, when the cam piece 3 is fixed to the driving shaft 2, the driving shaft 2 easily enters the groove, by which both are fixed firmly and deformation on the cam piece 3 side is small. Therefore, influence on the shape of the cam profile 33 can be reduced. Furthermore, if the grooves 34 are formed on the inner hole 31 at molding of the cam piece 3, there is no need to conduct machining and the productivity can be improved.

### Embodiment 2

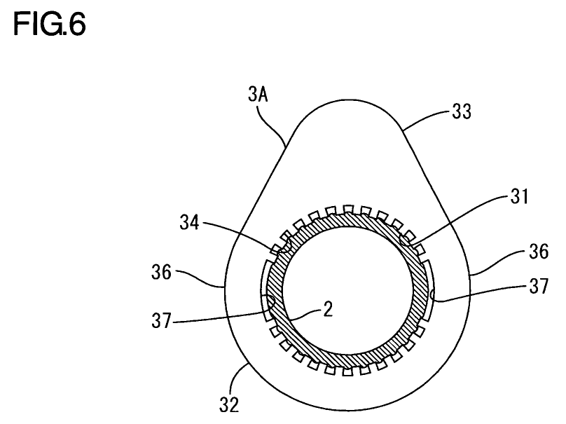

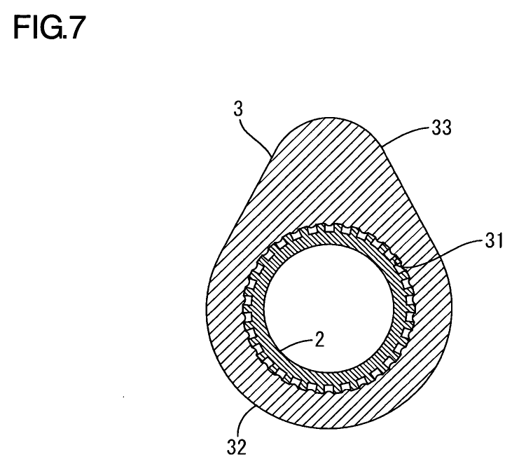

Next, feature portions of an embodiment 2 of the present invention will be described referring to FIG. 6. In the inner hole 31 of a cam piece 3A according to this embodiment, a plurality of grooves 34 are formed, which is similar to embodiment 1. The grooves 34 are formed in a series at a portion located inward of the cam profile 33 (upper part of the inner hole 31 in FIG. 6) and a portion opposite thereto and located inward of the circumferential-shaped outer circumferential surface 32 (lower part of the inner hole 31 in FIG. 6), respectively. Large-diameter escape portions 37 formed by hollowing the inner hole 31 outward are provided between the series of grooves 34 formed to be opposed to each other. The pair of escape portions 37 are opposed to each other and located inward of raised portions 36, which are portions where the circumferential-shaped outer circumferential surface 32 of the cam piece 3A continues to the cam profile 33. And the portions 37 extend circumferentially by the length of several grooves 34 so that the inner hole 31 is not brought into contact with the outer circumferential surface of the driving shaft 2 when the cam piece 3A is fastened to the driving shaft 2.

According to this embodiment, since the large-diameter escape portions 37 are formed at the portion located inward of the raised portions 36 so that contact with the outer circumferential surface of the driving shaft 2 can be avoided when the cam piece 3A is fastened to the driving shaft 2, change of the outer shape of the raised portions 36 can be further prevented even at a position close to the inner hole 31 and susceptible to the pressing force from the driving shaft 2 by fixation of the cam piece 3A to the driving shaft 2. It is to be noted that, since the cam profile 33 is located away from the inner hole 31, its outer shape is hardly changed, and the circumferential-shaped outer circumferential surface 32 is not brought into contact with the other part and does not function as a cam surface for controlling an operation amount of a valve member of an engine. Thus, it is not necessary to provide escape portions 37 at cam profile 33.

### Other Embodiments

The present invention is not limited to the embodiments described in the above description and drawings, but the following embodiments, for example, are included in the technical scope of the present invention, and various changes can be made other than the following without deviating from the scope of the present invention.

(1) The grooves may be formed on the outer circumferential surface side of the driving shaft; and

(2) The present invention can be applied to any rotating assemblies such as a steering shaft, a counter gear of a transmission or the like other than the camshaft.

1. A rotating assembly in which a rotating member is fixed onto a shaft by inserting the shaft into an inner hole of the rotating member, the rotating assembly comprising characterized in that:
a diameter of the inner hole is formed smaller than an outer diameter of an insertion portion of the shaft, and a plurality of grooves extending in the insertion direction are formed on one of the inner hole and an outer circumferential surface of the shaft;
wherein after the diameter of the inner hole is expanded by heating the rotating member, the shaft is inserted into the inner hole and cooled to reduce the diameter of the inner hole again, the other of the inner hole and the outer circumferential surface of the shaft is pressed and raised by the other part and enters the grooves so that both of them are fixed and formed.

2. The rotating assembly according to claim 1 wherein the rotating member is a cam piece having a circumferential-shaped outer circumferential surface surrounding the inner hole and a cam profile continuing to the outer circumferential surface and projecting outward, the plurality of grooves are formed in the inner hole, and by inserting the driving shaft into the inner hole, the cam piece is fastened onto the inner hole so as to form a camshaft.

3. The rotating assembly according to claim 2 wherein a portion in the inner hole positioned inward of the location where the circumferential-shaped outer circumferential surface continues to the cam profile, a large-diameter escape portion is formed to prevent contact with the outer circumferential surface of the driving shaft when the cam piece is fastened to the driving shaft.

4. The rotating assembly according to claim 2 wherein a hardness of the inner hole of the cam piece is higher than the hardness of the outer circumferential surface of the driving shaft.

5. A manufacturing method of a rotating assembly in which a rotating member is fixed onto a shaft by inserting the shaft into an inner hole of the rotating member, the method comprising:
forming a diameter of the inner hole to be smaller than an outer diameter of an insertion portion of the shaft, and forming a plurality of grooves extending in the insertion direction on one of the inner hole and an outer circumferential surface of the shaft, further heating the rotating member to expand the diameter of the inner hole, inserting the shaft into the inner hole and cooling to reduce the diameter of the inner hole, wherein one of the inner hole and the outer circumferential surface of the shaft is pressed and raised by the other and enters the grooves so that both are fixed.

6. The manufacturing method according to claim 5, wherein the plurality of grooves are formed on the inner hole.

7. The manufacturing method according to claim 6 wherein the rotating member is a cam piece having a cam profile continuing to the outer circumferential surface and projecting outward, and by inserting the shaft into the inner hole, the cam piece is fastened onto the inner hole so as to form a camshaft.

8. The manufacturing method according to claim 7, wherein a portion in the inner hole positioned inward of the location where the circumferential-shaped outer circumferential surface continues to the cam profile, a large-diameter escape portion is formed to prevent contact with the outer circumferential surface of the driving shaft when the cam piece is fastened to the driving shaft.

9. The manufacturing method according to claim 7, where in a hardness of the inner hole of the cam piece is higher than the hardness of the outer circumferential surface of the driving shaft.

10. The manufacturing method according to claim 5, wherein the forming of a plurality of grooves step includes forming the plurality of grooves from at least one of a trapezoidal shape, a circular shape, and a triangular shape.

11. A rotating assembly comprising:
a shaft having an insertion portion, wherein the insertion portion includes an outer diameter;
a rotating member having an inner hole, wherein the inner hole includes a diameter that is smaller than the outer diameter of the insertion portion, further wherein the rotating member is fixed onto the shaft by inserting the shaft into the inner hole of the rotating member,
a plurality of grooves extending in the insertion direction, wherein the plurality of grooves are positioned on at least one of the inner hole and an outer circumferential surface of the shaft;
wherein after the diameter of the inner hole is expanded by heating the rotating member, the shaft is inserted into the inner hole and cooled to reduce the diameter of the inner hole again, wherein the plurality of grooves are pressed into the shaft so that both of the inner hole and outer circumferential surface are fixed and formed.

12. The rotating assembly according to claim 11, wherein the plurality of grooves are formed on the inner hole.

13. The rotating assembly according to claim 12 wherein the rotating member is a cam piece having a cam profile continuing to the outer circumferential surface and projecting outward, and by inserting the shaft into the inner hole, the cam piece is fastened onto the inner hole so as to form a camshaft.

14. The rotating assembly according to claim 13, wherein a portion in the inner hole positioned inward of the location where the circumferential-shaped outer circumferential surface continues to the cam profile, a large-diameter escape portion is formed to prevent contact with the outer circumferential surface of the driving shaft when the cam piece is fastened to the driving shaft.

15. The rotating assembly according to claim 12, where in a hardness of the inner hole of the cam piece is higher than the hardness of the outer circumferential surface of the driving shaft.

16. The rotating assembly according to claim 11, wherein each of the plurality of grooves is formed in a circular shape.

17. The rotating assembly according to claim 11, wherein each of the plurality of grooves is formed in a triangular shape.

18. The rotating assembly according to claim 11, wherein each of the plurality of grooves is formed in a trapezoidal shape.

19. The rotating assembly according to claim 1, wherein the plurality of grooves are structured to be at least one of a trapezoidal shape, a circular shape, and a triangular shape.
